(19) United States
(12) Patent Application Publication
(10) Pub. No.: US 2026/0285634 A1
(43) Pub. Date: Sep. 24, 2026

(54) DEVICE AND METHOD FOR PROCESSING CONTINUOUS CARDBOARD WEB

(71) Applicant: HOMAG AUTOMATION GMBH, Lichtenberg (DE)

(72) Inventors: Torsten GOEHLER, Mulda (DE); Christian TIPPNER, Freiberg (DE)

(73) Assignee: HOMAG AUTOMATION GMBH, Lichtenberg (DE)

(21) Appl. No.: 19/145,782

(22) PCT Filed: Jan. 3, 2024
(86) PCT No.: PCT/EP2024/050076

§ 371 Date: Jul. 3, 2025

(30) Foreign Application Priority Data
Jan. 5, 2023 (DE) 10 2023 100 223.6

(51) Int. Cl. B65H 26/02; B31B 50/00; B31B 50/10; B31B 50/16; B31B 50/25; B31B 100/00; G01B 11/02

(52) U.S. Cl. CPC B65H 26/02; B31B 50/006; B31B 50/10; G01B 11/02; B31B 50/16; B31B 50/25; B31B 2100/00; B65H 2301/51; B65H 2553/40; B65H 2553/80

(57) ABSTRACT

A device for processing continuous cardboard web and for detecting creases, therein, in particular Leporello creases, as well as a method for the same. The device includes the following: a conveying device configured to convey continuous cardboard web in a conveying direction; at least one sensor configured to at least partially detect a surface of the continuous cardboard web while the continuous cardboard web is being conveyed and/or while it is stationary, and a controller configured to detect creases, in particular Leporello creases, in the continuous cardboard web by means of data relating to the surface that is collected by the sensor, characterized in that the sensor is furthermore configured to detect the surface of the continuous cardboard web in a linear manner or the controller is furthermore configured to approximate the surface of the continuous cardboard web in a linear manner by means of data collected by the sensor.

### TECHNICAL FIELD

The invention relates to a device and method for processing continuous cardboard web.

### PRIOR ART

So-called continuous cardboard webs are often used in industry, for instance for packaging products. Continuous cardboard web is, in general, cardboard that is not of infinite length in the mathematical sense, but the extension of which in one direction, which is usually the direction in which the continuous cardboard web is conveyed, is several times greater than in a direction transverse thereto. The continuous cardboard web is furthermore folded in a zigzag manner and is often, but not exclusively, stored on a pallet. This zigzag folding of the cardboard is often also referred to as Leporello folding, a fanfold or Z-folding, and these terms are used synonymously. The Leporello creases, i.e. the creases created by the zigzag folding of the continuous cardboard web, extend transversely to the longitudinal direction of the cardboard and divide it into sections of substantially equal length.

The advantage of continuous cardboard webs with Leporello folding is that they are particularly suitable for the automated production of cardboard boxes. For this purpose, the continuous cardboard web is often fed to a cardboard processing machine in an automated manner. The cardboard processing machine introduces folds and cuts that correspond to a desired layout of the cardboard box, and cuts the continuous cardboard web to length.

One disadvantage of using continuous cardboard web is the Leporello folding thereof. By means of the Leporello folding, the continuous cardboard web is divided into a plurality of sections of substantially equal length without any folds. The maximum length of the sections is usually limited by the length of the pallet on which the continuous cardboard web is stored.

During the automated processing of these continuous cardboard webs, it is often the case in practice that these Leporello creases are located in the region of adhesive tabs and introduced folds in the layout of the cardboard box that has been cut to size. This layout, also referred to as the cardboard design, is the blank of the cardboard box in the plane, i.e. the shape of the unfolded box. If there is a Leporello crease in the region of an adhesive tab of the cardboard box, this often leads in practice to the adhesive tab coming loose again after gluing. If there is a Leporello crease in the region of a fold introduced into the cardboard box by the cardboard processing machine, this often leads in practice to the cardboard box that has been cut to size being folded at a different point, i.e. at the Leporello crease, rather than at the intended point, i.e. the introduced fold. This has a negative effect on the dimensional accuracy of the packaging folded from the cardboard.

WO 2018/136658 A1 therefore proposes a mechanism for detecting Leporello creases, which detects the presence and location of Leporello creases by means of two sensors that are offset from one another in the conveying direction of the continuous cardboard web and that each measure the distance between the sensor and the surface of the cardboard. A Leporello crease is detected when each sensor individually detects a change in distance between the surface of the cardboard and the sensor, and when a time difference with which the two sensors each detect the change in distance corresponds to the conveying speed of the continuous cardboard web.

EP 3 521 006 A1 also proposes a mechanism for detecting Leporello creases, which uses sensors that measure the distance between the sensor and the surface of the cardboard to detect a Leporello crease. A Leporello crease is detected by a change in the distance between the surface of the cardboard and the sensor.

However, the solutions known from the prior art substantially have two disadvantages: On the one hand, relative movements of the continuous cardboard web relative to the sensor, for example due to vibrations during conveying of the continuous cardboard web or the like, can lead to measurement inaccuracies. Fluctuations in the conveying speed can additionally also lead to measurement inaccuracies. On the other hand, the measuring principle, i.e. measuring the distance between the sensor and the surface of the cardboard, makes it difficult or impossible to distinguish between Leporello creases and “other” creases, such as those caused by deflection of the continuous cardboard web via deflection rollers or by other manners of feeding, such as across guide rails. The latter have a much lower impact on the quality of the cardboard box than Leporello creases, which is why it is particularly desirable to be able to exclude areas with “other” creases from processing measures downstream of detection and thus ignore them.

### DESCRIPTION OF THE INVENTION

The invention is based on the object of providing a device and a method for processing continuous cardboard web, which are capable of reliably detecting creases, in particular Leporello creases, in a continuous cardboard web and, in particular, of thereby distinguishing between Leporello crease and creases which are caused, for example, by deflection of the cardboard via deflection rollers.

A device for processing continuous cardboard web is defined in claim 1. A method for processing continuous cardboard web is defined in claim 7. Dependent claims relate to specific embodiments.

The present invention provides a device for processing continuous cardboard web and for detecting creases therein, in particular Leporello creases. The device comprises a conveying device configured to convey continuous cardboard web in a conveying direction. The device furthermore comprises at least one sensor configured to at least partially detect a surface of the continuous cardboard web during conveying (while the continuous cardboard web is being conveyed and/or while it is stationary). The device furthermore comprises a controller configured to detect creases, in particular Leporello creases, in the continuous cardboard web by means of data relating to the surface that is collected by the sensor. The sensor is furthermore configured to determine/detect the surface of the continuous cardboard web in a linear manner and/or the controller is furthermore configured to determine/approximate the surface of the continuous cardboard web in a linear manner by means of data collected by the sensor.

As a result of the configuration of the device according to the invention, it is possible to detect creases present in continuous cardboard web in a particularly reliable manner, for example when manufacturing cardboard boxes from continuous cardboard web, and even if vibrations are acting on the continuous cardboard web. As a result hereof, the creases present in the continuous cardboard web can be taken into account, for example, when manufacturing cardboard boxes.

In the device described above, the sensor can be configured to detect the surface of the continuous cardboard web in a linear manner. Alternatively or additionally, the controller can be configured to approximate the surface of the continuous cardboard web in a linear manner by means of data collected by the sensor. In the present context, “in a linear manner” is not necessarily to be understood as linear in the mathematical sense. The surface of the continuous cardboard web is rather detected or approximated along a direction, and thus as a line, instead of being detected as a point or area. In the case of approximation, the line may be composed of a plurality of linear or non-linear line segments. In principle, detection during conveying means that at the moment of detection, the continuous cardboard web is either being moved by the conveying device or is temporarily stationary. As a result of the configuration of the device according to the invention, the surface of the cardboard is detected or approximated in a linear manner in a section at a specific point in time. Movement of the continuous cardboard web is therefore not important for the detection of creases, preferably Leporello creases. Detected creases can be taken into account when manufacturing cardboard boxes, for example, in such a manner that the controller specifies cuts and/or folds to a processing device in a way that a crease is not positioned within an adhesive tab of the layout or is not positioned so close to a fold to be introduced that, when a cardboard box that can be folded from such layout is folded manually or in an automated manner, the cardboard box would be folded at the Leporello crease rather than at the introduced fold. The distance between a fold to be introduced into the continuous cardboard web and a crease, such as a Leporello crease, is at least 1 cm, preferably at least 2 cm, more preferably at least 5 cm.

In a second preferred embodiment, the device is configured to carry out the linear detection of the surface by the sensor or the linear approximation of the surface by the controller at least not perpendicular, preferably substantially parallel to the conveying direction.

As a result of this configuration of the device according to the invention, a crease in the continuous cardboard web is detected particularly reliably during the linear detection of the surface and/or during the linear approximation of the surface. The creases to be detected in continuous cardboard webs usually run substantially perpendicular to the conveying direction of the continuous cardboard web. One benefit of aligning the line substantially parallel to the conveying direction is thus that if a crease is present, both an area of the surface in which the crease is located and, at the same time, an area of the surface in which the crease is not located is detected or approximated by the line.

In the preferred embodiment of the device as described above, the line is aligned to be at least not perpendicular to the conveying direction. The closer the alignment of the line is to parallel to the conveying direction, the more reliably a crease in the continuous cardboard web can be detected. This applies to both the case in which the surface is detected in a linear manner and to the case in which the surface is approximated in a linear manner. In the case of the linear approximation of the surface of the continuous cardboard web by means of a plurality of sensors that perform detection in a point-like manner, a scanning width, i.e. a distance between two points on the surface detected by the sensors, is selected such that the length of the approximated line along the surface of the cardboard is greater than the width of the crease to be detected. The width of creases to be detected depends on the thickness of the continuous cardboard web to be processed (which is usually between 2 and 7 mm thick) and is typically approximately 3 to 8 mm, but can be in the range of approximately 0.5 mm to 3 mm for thinner materials such as paperboard or paper and in the range of 5 to 10 mm for thicker materials. The length of the surface detected or approximated in a linear manner can, for example, be approximately 10 mm to 50 mm. The length of the surface detected or approximated in a linear manner is preferably approximately 2.5 times the width of the creases to be detected.

In a third preferred embodiment, the controller is furthermore configured to measure a length of the surface of the continuous cardboard web that is detected in a linear manner by the sensor or to calculate a length of the surface of the continuous cardboard web that is approximated in a linear manner by the controller. The controller is furthermore configured to detect creases, in particular Leporello creases, present in the continuous cardboard web on the basis of the length.

As a result of this configuration of the device according to the invention, creases in the continuous cardboard web can be detected in a particularly reliable manner and with high accuracy. The reason for this is that if there is a crease in the continuous cardboard web, the measured or calculated length of the surface of the continuous cardboard web is greater than if there is no crease in the continuous cardboard web. The measured or calculated length of the surface furthermore does not change or only changes very slightly in the event of vibrations or relative movements of the continuous cardboard web in the direction of the at least one sensor. The detection of creases based on length therefore also works particularly reliably in the event of vibrations or relative movements of the continuous cardboard web in the direction of the at least one sensor.

In a fourth preferred embodiment, the controller is furthermore configured to distinguish between Leporello creases and creases that are not Leporello creases when detecting creases.

As a result of this configuration of the device according to the invention, it is possible to distinguish between Leporello creases and other creases in the continuous cardboard web and thus to react differently to Leporello creases in subsequent processing steps than to creases that are not Leporello creases. This is particularly advantageous since creases can, for example, occur in the continuous cardboard web during conveying and deflection thereof, which are less disruptive than Leporello creases during further processing of the continuous cardboard web.

In the preferred embodiment of the device as described above, creases that are not Leporello creases are in particular creases that are caused when the continuous cardboard web is guided over deflection rollers or rolls and is intentionally or unintentionally creased in the process. Such creases are generally less pronounced, i.e. generally less deep, than Leporello creases which are caused by the folding of the continuous cardboard web.

In a fifth preferred embodiment, the sensor is a laser sensor that projects a laser line onto a section of the surface of the continuous cardboard web.

As a result of this configuration of the device according to the invention, a user can the alignment of the linear detection area of the surface, which should preferably be substantially parallel to the conveying direction, can be easily checked by the operator. Such a check can be carried out, for example, when the device is first set up or when it is adapted to other thicknesses or strengths of the continuous cardboard web. It is thereby advantageous if the laser operates in the wavelength range of visible light. In wavelength ranges outside of visible light, the linear detection area can be made visible, for example, by using appropriate cameras.

In a sixth preferred embodiment, the device further comprises a processing device that is configured to introduce cuts and/or folds into the continuous cardboard web in accordance with a layout of a cardboard box predetermined by the controller. If a Leporello crease is detected, the controller is furthermore configured to take the position of the Leporello crease into account when providing specifications for cuts and/or folds to the processing device.

As a result of this configuration of the device according to the invention, the position of a Leporello crease present in the continuous cardboard web can be taken into account when manufacturing the cardboard box, and the position of the layout of the cardboard box to be Introduced into the continuous cardboard web can be adapted to the position of the Leporello crease. This layout, also referred to as the cardboard design, is the blank of the cardboard box in the plane, i.e. the shape of the unfolded box.

In a preferred embodiment, when providing specifications for cuts and/or folds to the processing device, the controller takes into account the position of the Leporello crease such that a Leporello crease is not positioned within an adhesive tab of the layout; or such that a Leporello crease is positioned at least 1 cm, preferably at least 2 cm, more preferably at least 5 cm away from a fold to be introduced; or such that a Leporello crease is positioned outside the layout of the cardboard box.

As a result of this configuration of the device according to the invention, it can be effectively prevented that a Leporello crease is located in an adhesive tab of a cardboard box produced from the continuous cardboard web. This prevents the adhesive tab from unintentionally coming loose again after it has been glued due to the presence of a Leporello crease. As a result of the above configuration according to the invention, it can furthermore be prevented that when folding the cardboard box produced from the continuous cardboard web, the cardboard box is creased at a point where a Leporello crease is present, instead of being creased at a point where a fold introduced by the processing device is present. The dimensional accuracy of the cardboard box or packaging folded from the cardboard box can thus be improved. It can furthermore also be prevented that a Leporello crease is located in the layout of a cardboard box at all. The section of the continuous cardboard web in which the Leporello crease is located is thereby separated by the processing device, and the layout is positioned on the continuous cardboard web in such a manner that no Leporello crease is located in the layout. This is especially desirable if particularly high demands are placed on the surface quality of the cardboard box.

The present invention furthermore provides a method for processing continuous cardboard web and for detecting creases therein, in particular Leporello creases. The method comprises the steps of: conveying a continuous cardboard web in a conveying direction; detecting at least part of a surface of the continuous cardboard web, preferably during conveying (while the continuous cardboard web is being conveyed and/or while it is stationary), by means of at least one sensor; determining (detecting/approximating) a length of the surface of the continuous cardboard web in a linear section of the surface of the continuous cardboard web, which linear section extends preferably parallel to the conveying direction; and detecting a crease, in particular a Leporello crease, on the basis of the length of the linear section of the surface of the continuous cardboard web.

As a result of the method according to the invention, it is possible to detect creases present in a continuous cardboard web in a particularly reliable manner. The reason for this is that if there is a crease in the continuous cardboard web, the measured or calculated length of the surface in a linear section of the surface of the continuous cardboard web is greater than if there is no crease in this linear section of the continuous cardboard web. The measured or calculated length of the surface of the continuous cardboard web in the linear section furthermore does not change or only changes very slightly in the event of vibrations or relative movements of the continuous cardboard web in the direction of the at least one sensor. The detection of creases based on the length of the surface in the linear section therefore also works particularly reliably in the event of vibrations or relative movements of the continuous cardboard web in the direction of the at least one sensor. One benefit of aligning the linear section substantially parallel to the conveying direction is that if a crease is present, the length of the surface in the linear section changes. In contrast, if both the crease and the linear section were perpendicular to the conveying direction, the length of the surface in the linear section with a crease in this section would, in the worst-case scenario, not differ from the length of the surface in the linear section without a crease.

In a preferred embodiment of the method, the length of the surface in the linear section that extends preferably parallel to the conveying direction is determined in that the surface is detected in a linear manner by a laser sensor.

As a result of this configuration of the method according to the invention, the length of the surface in the linear section can be measured directly and thus determined with particular accuracy. As a result, even small changes in length can be detected and, in particular, a distinction can be made between creases of different degrees. A distinction can therefore in particular be made between Leporello creases and creases that are not Leporello creases. Owing to the use of a laser sensor that detects the surface in a linear manner, it is already sufficient to provide a single sensor for detecting creases. If a laser sensor with a wavelength in the visible light range is used, a user can easily set the alignment of the laser line such that it is substantially parallel to the conveying direction and check this.

In another preferred embodiment of the method, the length of the surface in the linear section that extends preferably parallel to the conveying direction is determined in that a part of the surface of the continuous cardboard web is detected by at least two, preferably at least three laser sensors which are arranged at a distance to one another in the direction of extension of the linear section to be detected, and which detect the surface of the continuous cardboard web in a point-like manner and at the same time; and in that the straight-line distance or straight-line distances between the points respectively detected by the sensors on the surface of the continuous cardboard web is/are calculated.

As a result of this configuration of the method according to the invention, creases in the continuous cardboard web can also be detected particularly reliably even if a laser sensor that detects the surface in a linear manner is not used, but instead at least two less expensive laser sensors that detect the surface in a point-like manner are used. A less expensive configuration can be provided in this manner while still ensuring reliable detection of creases in the continuous cardboard web even in the event of vibrations or relative movements of the continuous cardboard web in the direction of the at least two sensors.

### BRIEF DESCRIPTION OF THE DRAWINGS

Further features and advantages of the device and method are apparent from the following description of embodiments with reference to the accompanying figures. These figures show the following:

FIG. 1 a perspective, schematic view of an embodiment of a device according to the disclosure for processing continuous cardboard web and for detecting creases contained therein.

FIG. 2 a perspective, schematic view of the continuous cardboard web and the sensor for detecting creases in the continuous cardboard web.

FIG. 3A a schematic view, transverse to the conveying direction of the continuous cardboard web on its cross-sectional surface, of an embodiment of a sensor according to the disclosure for detecting creases in the continuous cardboard web, which sensor detects part of the surface of the continuous cardboard web in a linear manner parallel to the conveying direction, the continuous cardboard web having no crease.

FIG. 3B a schematic view, transverse to the conveying direction of the continuous cardboard web on its cross-sectional surface, of an embodiment of a sensor according to the disclosure for detecting creases in the continuous cardboard web, which sensor detects part of the surface of the continuous cardboard web in a linear manner parallel to the conveying direction, the continuous cardboard web having a crease that is not a Leporello crease but is rather caused by deflection of the continuous cardboard web over deflection rollers.

FIG. 3C a schematic view, transverse to the conveying direction of the continuous cardboard web on its cross-sectional surface, of an embodiment of a sensor according to the disclosure for detecting creases in the continuous cardboard web, which sensor detects part of the surface of the continuous cardboard web in a linear manner parallel to the conveying direction, the continuous cardboard web having a Leporello crease.

FIG. 4A a schematic view, transverse to the conveying direction of the continuous cardboard web on its cross-sectional surface, of another embodiment having three sensors according to the disclosure for detecting creases in the continuous cardboard web, which sensors detect part of the surface in a point-like manner, the continuous cardboard web having no crease.

FIG. 4B a schematic view, transverse to the conveying direction of the continuous cardboard web on its cross-sectional surface, of another embodiment having three sensors according to the disclosure for detecting creases in the continuous cardboard web, which sensors detect part of the surface in a point-like manner, the continuous cardboard web having a crease that is not a Leporello crease but is rather caused by deflection of the continuous cardboard web over deflection rollers.

FIG. 4C a schematic view, transverse to the conveying direction of the continuous cardboard web on its cross-sectional surface, of another embodiment having three sensors according to the disclosure for detecting creases in the continuous cardboard web, which sensors detect part of the surface in a point-like manner, the continuous cardboard web having a Leporello crease.

FIG. 5 a schematic view, transverse to the conveying direction of the continuous cardboard web on its cross-sectional surface, of another embodiment having three sensors according to the disclosure for detecting creases in the continuous cardboard web, which sensors detect part of the surface in a point-like manner, the continuous cardboard web having a Leporello crease and being shifted parallel by vibrations in the detection direction of the sensors.

FIG. 6A a schematic top view of part of the continuous cardboard web with an indicated layout of the cardboard box, wherein in the left-hand layout, a Leporello crease is undesirably located on an adhesive tab.

FIG. 6B a schematic top view of part of the continuous cardboard web with an indicated layout of the cardboard box, wherein in the left-hand layout, a Leporello crease is located so close to an introduced fold that when folding a cardboard box that can be folded from the layout, the cardboard box would not be folded at the introduced fold but rather at the Leporello crease, and wherein in the right-hand layout, a Leporello crease is located at a position that is not critical for folding.

### DESCRIPTION OF EMBODIMENTS

Identical reference numbers used in different figures designate identical, corresponding or functionally similar elements.

The method according to the invention can preferably be carried out using a device according to the invention. The device according to the invention can preferably carry out a method according to the invention.

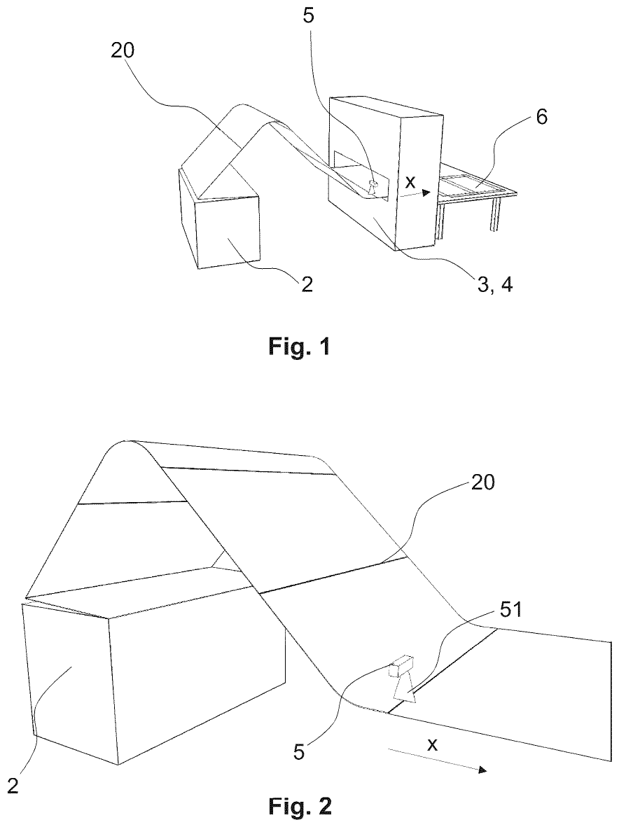

A preferred embodiment of the device for processing continuous cardboard web 2 and for detecting creases therein is shown in FIG. 1. Continuous cardboard web 2 is to be understood here as meaning materials such as paperboard, corrugated cardboard and cardboard that are commonly used in the packaging industry. However, by parameterising the controller accordingly, which will be discussed in more detail later, creases in thinner materials such as paper, film or the like and creases in thicker materials can also be reliably detected.

The device comprises a conveying device 3 and preferably a processing device 4. The conveying device 3 can convey the continuous cardboard web 2 to or through a processing device 4. During conveying, the continuous cardboard web 2 can be guided over deflection rollers in order to adapt the device to the available space at the installation site and to ensure a reliable unfolding of the continuous cardboard web 2 from the stack of zigzag-folded continuous cardboard web 2. FIG. 1 shows a deflection of the continuous cardboard web 2, but the deflection roller has been omitted for a better overview. There are Leporello creases 20 in the continuous cardboard web 2 due to the zigzag folding.

A sensor 5 is provided in front of the processing device 4, which detects a section A of the surface of the continuous cardboard web 2. It is preferred that the sensor 5 detects the section A of the surface in a linear manner. The various possibilities for configuring the sensor 5 will be discussed in detail later.

Based on the data supplied by the sensor 5, a controller detects whether a Leporello crease 20 is present in the continuous cardboard web 2. The processing device 4 downstream of the sensor 5 makes cuts and/or folds 62 in the continuous cardboard web 2 in order to provide a layout of a cardboard box in the continuous cardboard web 2 in accordance with the specifications of a controller. This layout can then be removed from the continuous cardboard web 2 as a cardboard box and can be folded and/or glued into packaging either by hand or by machine. Alternatively, the processing device 4 can also be configured in such a manner that it removes the parts of the continuous cardboard web 2 that are not part of the layout by cutting and feeds them to a waste disposal unit, so that the finished cardboard box can already be removed from the processing device 4 or can be folded by machine.

FIG. 2 shows a preferred embodiment of the sensor 5, which detects a section A of the surface of the continuous cardboard web 2 in a linear manner. The conveying direction of the continuous cardboard web 2 is indicated by an arrow. It is apparent that the area that is detected or scanned by the sensor 5 in a linear manner is aligned substantially parallel to the conveying direction x and thus also substantially perpendicular to the Leporello creases 20 in the continuous cardboard web 2.

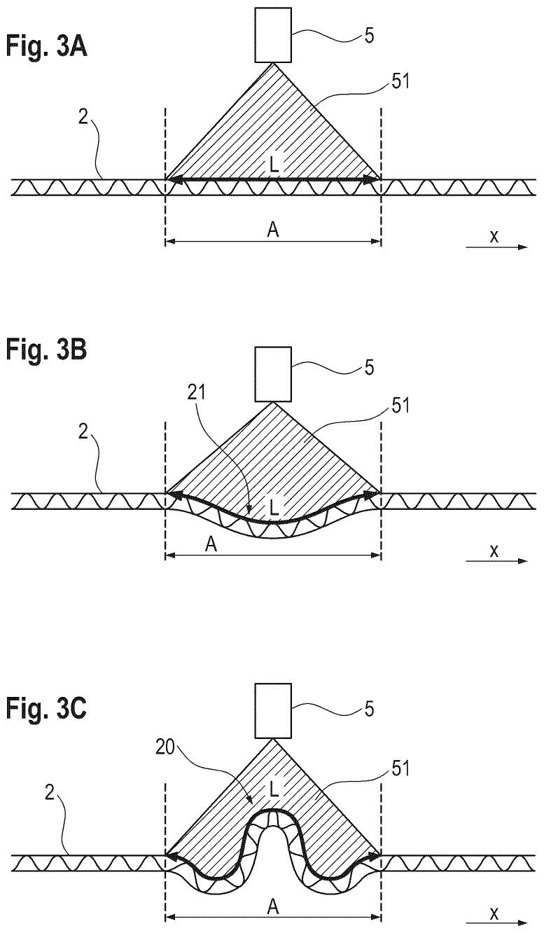

The principle of detecting a crease 20, 21 using this preferred embodiment of the device having a sensor 5 that detects a section A (detection section) of the surface of the continuous cardboard web 2 in a linear manner is shown in FIGS. 3A to 3C. FIGS. 3A to 3C each show the cross-section of a continuous cardboard web 2 made, for example, of corrugated cardboard, which is conveyed from left to right and the surface of which is detected or scanned in part by a sensor 5 in a linear manner. The sensor 5 thereby projects a laser line 51 onto part of the surface of the continuous cardboard web 2. This means that not just one point P on the surface of the continuous cardboard web 2 is detected at a point in time, but rather an entire linear section A is detected or scanned at a point in time. A controller integrated in the sensor 5 or configured separately thus receives data relating to the surface of the continuous cardboard web 2 in this entire linear detection section A at a single point in time. The controller can thus measure or calculate a length L along the surface of the continuous cardboard web 2 in the linear detection section A.

FIG. 3A shows a continuous cardboard web 2 with a substantially smooth surface, i.e. without creases 20, 21. In comparison, FIG. 3B shows a continuous cardboard web 2 with a crease 21 that is not a Leporello crease 20. Owing to the curvature of the surface, the length L of the surface detected by the sensor 5 in the linear detection section A and measured by the controller also increases. The length L therefore increases if there is a crease 20, 21 in the continuous cardboard web 2. FIG. 3C shows a continuous cardboard web 2 with a Leporello crease 20. Since continuous cardboard webs 2 are often manufactured and folded while still wet, the Leporello creases 20, which are created by folding the continuous cardboard web 2, are particularly pronounced. As a result of the correspondingly more pronounced curvature of the surface, the length L of the surface detected by the sensor 5 in the linear detection section A and measured by the controller also increases. The length L thus becomes a very reliable indicator of whether there is a crease 20, 21 in the continuous cardboard web 2. It can furthermore be determined based on the length L whether the crease is a Leporello crease 20 or a crease 21 that is not a Leporello crease 20. For example, a length L of the surface with a crease 21 that is not a Leporello crease 20 may be 1% to 5% longer, preferably 1 to 2.5% longer than a length L of the surface without a crease. A length L of the surface with a Leporello crease 20 may, for example, be more than 5%, preferably more than 2.5% longer than the length of the surface without a crease. Classification of the surface as “no crease”, “crease that is not a Leporello crease” and “Leporello crease” can therefore be carried out based on limit values of the length L. Detection and classification can also be adapted to materials having a different thickness, such as paper, paperboard or films, by parameterising the limit values for the length L accordingly.

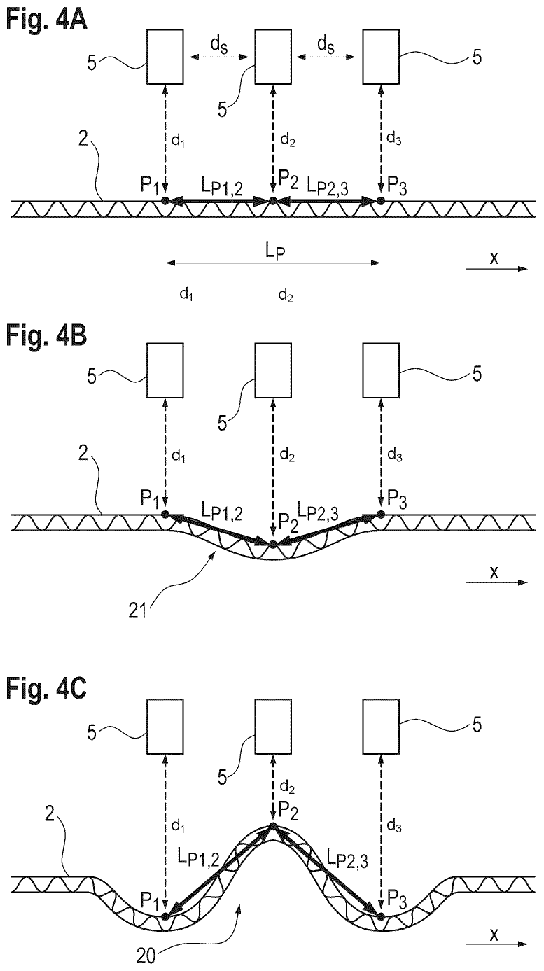

The principle of detecting a crease 20, 21 using another preferred embodiment of the device having at least two, preferably at least three sensors that detect a section A of the surface of the continuous cardboard web 2 in a point-like manner is shown in FIGS. 4A to 4C. FIGS. 4A to 4C each show the cross-section of a continuous cardboard web 2 made, for example, of corrugated cardboard, which is conveyed from left to right and the surface of which is detected or scanned in part by two, preferably three sensors in a point-like manner. Each of the sensors thereby projects a laser point P onto part of the surface of the continuous cardboard web 2. This means that not just one point P on the surface of the continuous cardboard web 2 is detected at a point in time, but rather at least two, preferably three points P₁, P₂, P₃ distributed over a section A are detected or scanned at a point in time. A controller that is preferably configured separately thus receives data relating to the distance d₁, d₂, d₃ of two, preferably three points P₁, P₂, P₃ on the surface of the continuous cardboard web 2 from the respective sensors at a single point in time. Using the distance d_{S} between the respective sensors 5, the controller can therefore trigonometrically calculate a length L_{P1,2}, L_{P2,3} of a straight-line distance between two points P₁, P₂, P₃ on the surface of the continuous cardboard web 2 detected by the sensors 5 by means of the following formulae:

$${L}_{P 1 , 2} = \sqrt{{( {d}_{2} - {d}_{1} )}^{2} + {d}_{S}^{2}}$$

$${L}_{P 2 , 3} = \sqrt{{( {d}_{3} - {d}_{2} )}^{2} + {d}_{S}^{2}}$$

When using two sensors 5 carrying out measurement in a point-like manner, the length L, which was measured directly by a sensor 5 carrying out detection in a linear manner in the other preferred embodiment, can now be approximated by the controller by means of the linear distance L_{P1,2} between the two detected points P₁, P₂. In the case of the preferred use of three or more sensors 5 carrying out measurement in a point-like manner, the length L can be approximated by adding together the linear distances L_{P1,2}, L_{P2,3} between the points P₁, P₂, P₃ detected on the surface of the continuous cardboard web 2:

$$L \approx {L}_{P} = {L}_{P 1 , 2} + {L}_{P 2 , 3} + … + {L}_{P ( n - 1 ) , n}$$

As a result of this embodiment, it is possible to dispense with a more cost-intensive sensor 5 carrying out measurement in a linear manner and still use the principle according to the invention described above in connection with FIGS. 3A to 3C for detecting creases in a continuous cardboard web 2.

The principle according to the invention of detecting the presence of creases in a continuous cardboard web 2 on the basis of a length L, L_{P} of a surface of the continuous cardboard web 2 in a linear section A offers a plurality advantages over solutions known in the prior art:

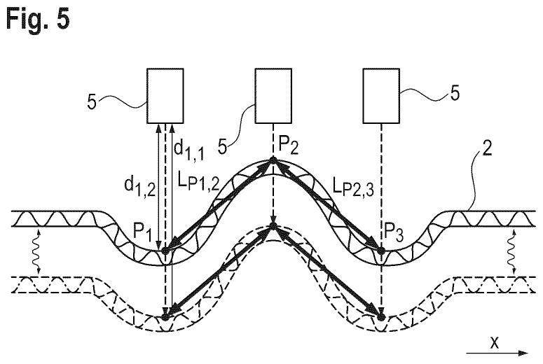

FIG. 5 shows a case in which a continuous cardboard web 2 is subjected to vibration or relative movement in the direction of the sensors. Although sensors measuring in a point-like manner 5 are shown in FIG. 5, the following advantages likewise apply to a sensor 5 measuring in a linear manner. When the continuous cardboard web 2 vibrates, the distances d₁, d₂, d₃ between the surface of the continuous cardboard web 2 and the sensors or sensor 5 change. For example, the distance d_{1,1} at one point in time can be greater or smaller than the distance d_{1,2} at a second point in time due to the vibration. This leads to measurement inaccuracies in devices having detection that is based on measurement of the distance between the surface of the continuous cardboard web 2 and the sensor 5. However, as is clearly apparent from FIG. 5, a length L, L_{P} of a surface in a linear section A does not change or only changes slightly in the event of vibrations or relative movements in the direction of the sensor 5. It is irrelevant whether the length is approximated or measured directly. Thus, a detection of a crease 20, 21 in the continuous cardboard web 2, which is based on the measurement or calculation of a length L, L_{P} of the surface in a linear section A, is significantly more robust against vibrations and relative movements than a detection based on the measurement of the distance between the surface and the continuous cardboard web 2 to the sensor 5.

This effect is further enhanced by the fact that the entire length L, L_{P} is detected or approximated at a single point in time and thus neither the conveying movement of the continuous cardboard web 2 nor vibrations or other relative movements can negatively influence detection. In other words: Owing to the fact that a plurality measuring points are detected at the same point in time and a length is calculated or approximated on the basis thereof, vibrations, relative movements or fluctuations in the conveying speed have no or at least a significantly lower influence on the detection of creases in the continuous cardboard web 2.

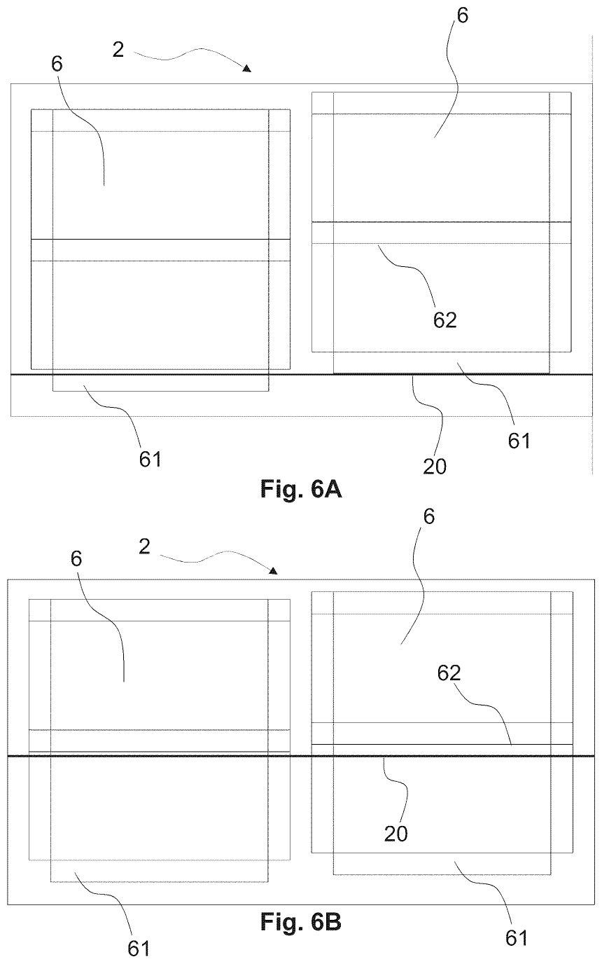

FIGS. 6A and 6B show how a processing device 4 downstream of the at least one sensor 5 can use the information about the presence of a crease 20, 21. The figures show a projection of layouts 6 onto a continuous cardboard web 2 with the Leporello crease 20. If the controller detects that a crease 20, 21, in particular a Leporello crease 20, is present in the continuous cardboard web 2, the controller issues instructions to the processing device 4 so that in a layout 6 of a cardboard box introduced into the continuous cardboard web 2 by the processing device 4, a Leporello crease 20 is arranged neither in the region of an adhesive tab 61 (left in FIG. 6A) nor in a region of a fold 62 introduced by the processing device 4 (left in FIG. 6B). The instruction may, for example, be to shift the layout 6 of the cardboard box forwards or backwards in the longitudinal direction of the continuous cardboard web 2 or to geometrically adjust the layout of the cardboard box. The processing device 4 may furthermore provide waste cuts in order to separate areas with Leporello creases 20 or to enable a shifting of the layout 6 of the cardboard box.

It is apparent to the person skilled in the art that individual features described in different embodiments may also be implemented in a single embodiment, provided that they are not structurally incompatible. Similarly, various features described in the context of a single embodiment may also be provided in several embodiments either individually or in any suitable sub-combination.

### LIST OF REFERENCE NUMBERS

Continuous cardboard web 2
Leporello crease 20
Other crease 21
Conveying device 3
Processing device 4
Sensor 5
Laser line 51
Layout 6
Adhesive tab 61
Fold 62
Linear section A
Distance between two sensors d_{S}
Distance between sensor and detected point d₁, d₂, d₃
Length of the surface L
Approximated length of the surface L_{P}
Straight line distance between two points L_{P1,2}, L_{P2,3}
Detected point on the surface P₁, P₂, P₃
Conveying direction x

1. A device for processing continuous cardboard web and for detecting creases therein, including Leporello creases, said device comprising:
a conveying device configured to convey continuous cardboard web in a conveying direction;
at least one sensor configured to at least partially detect a surface of the continuous cardboard web during conveying; and
a controller configured to detect creases, including Leporello creases, present in the continuous cardboard web by way of data relating to the surface that is collected by the sensor, wherein
the sensor is furthermore configured to at least partially detect the surface of the continuous cardboard web in a linear manner,
or
the controller is furthermore configured to at least partially approximate the surface of the continuous cardboard web in a linear manner by way of data collected by the sensor.

2. The device according to claim 1, wherein the sensor is further configured to carry out linear detection of the surface or wherein linear approximation of the surface by the controller at least not perpendicular to the conveying direction.

3. The device according to claim 1, wherein the controller is furthermore configured
to measure a length of the surface of the continuous cardboard web that is detected in a linear manner by the sensor or to calculate a length of the surface of the continuous cardboard web that is approximated in a linear manner by the controller;
and to detect creases, including Leporello creases, present in the continuous cardboard web on the basis of the measured or calculated length.

4. The device according to claim 3, wherein the controller is furthermore configured to distinguish between Leporello creases and creases that are not Leporello creases when detecting creases.

5. The device according to claim 1, wherein the sensor is a laser sensor and is configured to project a laser line onto a section of the surface of the continuous cardboard web in order to detect the surface.

6. The device according to claim 1, further comprising a processing device that is configured to introduce cuts and/or folds into the continuous cardboard web in accordance with a layout of a cardboard box predetermined by the controller, wherein
the controller is furthermore configured, in an event of detection of a Leporello crease, to take a position of the Leporello crease into account when providing specifications for cuts and/or folds to the processing device.

7. The device according to claim 6, wherein when providing specifications for cuts and/or folds to the processing device, the controller takes into account the position of the Leporello crease such that
a Leporello crease is not positioned within an adhesive tab of the layout; or
a Leporello crease is positioned at least 1 cm away from a fold to be introduced; or
a Leporello crease is positioned outside the layout of the cardboard box.

8. A method for processing continuous cardboard web and for detecting creases therein, including Leporello creases, said method comprising:
conveying a continuous cardboard web in a conveying direction;
detecting at least part of a surface of the continuous cardboard web by way of at least one sensor;
determining a length of the surface in a linear section of the surface of the continuous cardboard web, which linear section extends parallel to the conveying direction; and
detecting a crease, including a Leporello crease, on the basis of the length of the surface of the continuous cardboard web in the linear section.

9. The method according to claim 8, wherein the length of the surface of the continuous cardboard web in the linear section that extends parallel to the conveying direction is determined in that the section is detected in a linear manner by a laser sensor.

10. The method according to claim 8, wherein the length of the surface of the continuous cardboard web in the linear section that extends preferably parallel to the conveying direction is determined in that
part of the surface of the continuous cardboard web is detected by at least two, laser sensors which are arranged at a distance to one another in the direction of extension of the linear section to be detected, and which each detect the surface of the continuous cardboard web in a point-like manner and at the same time; and in that
a straight-line distance or straight-line distances between the points respectively detected by the sensors on the surface of the continuous cardboard web is/are calculated.

11. The device according to claim 1, wherein the sensor is further configured to carry out linear detection of the surface or wherein linear approximation of the surface by the controller that is substantially parallel to the conveying direction.

12. The device according to claim 2, wherein the controller is further configured to
measure a length of the surface of the continuous cardboard web that is detected in a linear manner by the sensor or to calculate a length of the surface of the continuous cardboard web that is approximated in a linear manner by the controller; and
detect creases, including Leporello creases, present in the continuous cardboard web on the basis of the measured or calculated length.

13. The device according to claim 2, wherein the sensor is a laser sensor and is configured to project a laser line onto a section of the surface of the continuous cardboard web in order to detect the surface.

14. The device according to claim 3, wherein the sensor is a laser sensor and is configured to project a laser line onto a section of the surface of the continuous cardboard web in order to detect the surface.

15. The device according to claim 4, wherein the sensor is a laser sensor and is configured to project a laser line onto a section of the surface of the continuous cardboard web in order to detect the surface.

16. The device according to claim 2, further comprising a processing device that is configured to introduce cuts and/or folds into the continuous cardboard web in accordance with a layout of a cardboard box predetermined by the controller, wherein
the controller is furthermore configured, in an event of detection of a Leporello crease, to take a position of the Leporello crease into account when providing specifications for cuts and/or folds to the processing device.

17. The device according to claim 3, further comprising a processing device that is configured to introduce cuts and/or folds into the continuous cardboard web in accordance with a layout of a cardboard box predetermined by the controller, wherein
the controller is furthermore configured, in an event of detection of a Leporello crease, to take a position of the Leporello crease into account when providing specifications for cuts and/or folds to the processing device.

18. The device according to claim 4, further comprising a processing device that is configured to introduce cuts and/or folds into the continuous cardboard web in accordance with a layout of a cardboard box predetermined by the controller, wherein
the controller is furthermore configured, in an event of detection of a Leporello crease, to take a position of the Leporello crease into account when providing specifications for cuts and/or folds to the processing device.

19. The device according to claim 5, further comprising a processing device that is configured to introduce cuts and/or folds into the continuous cardboard web in accordance with a layout of a cardboard box predetermined by the controller, wherein
the controller is furthermore configured, in an event of detection of a Leporello crease, to take a position of the Leporello crease into account when providing specifications for cuts and/or folds to the processing device.

20. The device according to claim 6, wherein when providing specifications for cuts and/or folds to the processing device, the controller takes into account the position of the Leporello crease such that a Leporello crease is positioned at least 5 cm away from a fold to be introduced.
